(19) United States
(12) Patent Application Publication
(10) Pub. No.: US 2020/0008003 A1
(43) Pub. Date: Jan. 2, 2020

(54) PRESENCE-BASED VOLUME CONTROL SYSTEM

(71) Applicant: Walmart Apollo, LLC, Bentonville, AR (US)

(72) Inventors: John Paul Thompson, Bentonville, AR (US); Eric A. Letson, Bentonville, AR (US)

(21) Appl. No.: 16/459,840

(22) Filed: Jul. 2, 2019

Related U.S. Application Data
(60) Provisional application No. 62/692,944, filed on Jul. 2, 2018.

(51) Int. Cl. H04S 7/00; H04S 3/00; H04R 5/02; H04R 5/04; G06F 3/01

(52) U.S. Cl. CPC H04S 7/303; H04S 3/008; H04R 5/02; H04S 2400/13; G06F 3/011; H04S 2400/01; H04R 5/04

(57) ABSTRACT

Provided is a presence-based volume control system. The system may include a surround sound receiver and a volume control unit coupled in-line between a speaker and the surround sound receiver. The volume control unit may include a microprocessor, a position sensor coupled to the microprocessor, an audio input coupled to the surround sound receiver, an audio output coupled to the speaker, and an audio amplifier coupled to and controlled by the microprocessor and coupled to the audio input and the audio output. In operation, the position sensor determines a position of a user of a virtual reality device, an augmented reality device or a mixed reality device and the microprocessor automatically adjusts a volume of the speaker coupled to the surround sound receiver in response to the proximity of the user to the speaker.

### RELATED APPLICATION

This application claims priority to U.S. Provisional Patent Application Ser. No. 62/692,944 to Walmart Apollo, LLC, filed Jul. 2, 2018 and entitled “Presence-based Volume Control System”, which is hereby incorporated entirely herein by reference.

### FIELD OF THE INVENTION

The invention relates generally to volume control, and more specifically, to a presence-based volume control system.

### BACKGROUND

Virtual reality devices are becoming more commonplace. Conventionally, the audio existing today for virtual reality headsets and personal computers work best for headphones and thereby require the use of headphones in order to experience the full emersion of virtual reality. These conventional headphones lack the ability to have room-based audio, such as surround sound systems including, but not limited to 5.1 and 7.1 type systems.

### BRIEF SUMMARY

In one aspect, provided is a presence-based volume control system for mixed reality, the system comprising: a surround sound receiver; and a volume control unit coupled in-line between a speaker and the surround sound receiver, the volume control unit comprising: a microprocessor; a position sensor coupled to the microprocessor; an audio input coupled to the surround sound receiver; an audio output coupled to the speaker; and an audio amplifier coupled to and controlled by the microprocessor and coupled to the audio input and the audio output, wherein the position sensor determines a position of a user of a virtual reality device, an augmented reality device or a mixed reality device and the microprocessor automatically adjusts a volume of the speaker coupled to the surround sound receiver in response to the proximity of the user to the speaker.

In another aspect, provided is a presence-based volume control system for mixed reality, the system comprising: a surround sound receiver having multiple audio channels; and a plurality of volume control units, wherein each volume control unit coupled in-line between a speaker associated with one audio channel of the multiple audio channels and the surround sound receiver, each volume control unit comprising: a microprocessor; a position sensor coupled to the microprocessor; an audio input coupled to the surround sound receiver; an audio output coupled to the speaker; and an audio amplifier coupled to and controlled by the microprocessor and coupled to the audio input and the audio output, wherein the position sensor determines a position of a user of a virtual reality device, an augmented reality device or a mixed reality device and the microprocessor automatically adjusts a volume of the speaker associated with the one audio channel coupled to the surround sound receiver in response to the proximity of the user to the speaker.

In another aspect, provided is a presence-based volume control system for mixed reality, the system comprising: a surround sound receiver having multiple audio channels; and a plurality of volume control units, wherein each volume control unit coupled in-line between a speaker associated with one audio channel of the multiple audio channels and the surround sound receiver, each volume control unit comprising: a microprocessor; a position sensor coupled to the microprocessor; an audio input coupled to the surround sound receiver; an audio output coupled to the speaker; and an audio amplifier coupled to and controlled by the microprocessor and coupled to the audio input and the audio output, wherein: each volume control unit of the plurality of volume control units operates independently from the other volume control units; and the position sensor of each volume control unit determines a position of a user of a virtual reality device, an augmented reality device or a mixed reality device and the microprocessor automatically adjusts a volume of the speaker coupled to the volume control unit coupled to the speaker in response to the proximity of the user to the speaker in order to adjust the volume of all of the speakers of the system.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustrative view of a presence-based volume control system in accordance with some embodiments.

FIG. 2 is a block diagram of the presence-based volume control system of FIG. 1, in accordance with some embodiments.

### DETAILED DESCRIPTION

The use of virtual reality (“VR”) devices is becoming more and more common. Additionally, devices are being used for augmented reality (“AR”) and mixed reality (“MR”). These devices give users different options for interacting with certain environments, such as a standard virtual environment using a VR device, or a mixed or augmented environment that combines elements form a virtual environment and a real environment. These devices are changing and providing additional features. These devices are allowing a user to be immersed within the environment and accomplishes such even more by the addition of sound. Conventionally, that sound is handled by use of headphones connected to the VR or AR device.

The present inventive concepts operate to allow for use of VR devices and/or AR devices within a room-based audio system. The room-based audio system may be a 5.1 surround sound system, 7.1 surround sound system, Atmos system or other type of room-based audio system. The present inventive concept incorporates presence-based control of the speakers of the room-based audio system.

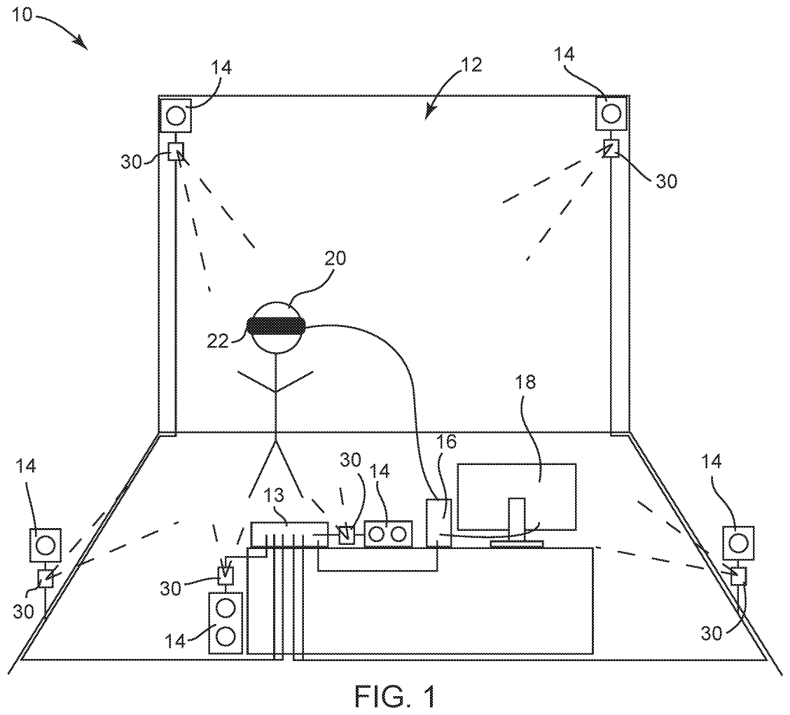

FIG. 1 is an illustrative view of an embodiment of a presence-based volume control system 10 used within a room 12. The system may include an audio receiver 13 with a plurality of speakers 14. FIG. 1 depicts a 5.1 type system with two front speakers, two rear speakers, a center speaker and a subwoofer. The system 10 further includes a plurality of presence-based volume control device 30, wherein each volume control device 30 is coupled in-line between one speaker 14 and the receiver 13. The receiver 13 may be coupled to a computing device 16 that may have a screen 18. The computing device 16 may operate software driving the VR device/AR device 22 used by user 20.

In operation, within room 12, system 10, sound from the VR computer 16 connected to the VR device 22 is sent to the surround sound receiver 13 having the plurality of speakers 14 placed throughout the VR room 12. As VR user 20 gets close to a speaker 14, the volume control device 30 coupled in-line between the receiver 13 and the speaker 14 operates to sense the location of the user 20 and adjusts the volume of the audio provided through the speaker 14. As the user 20 walks away from the speaker 14, volume of the audio would be adjusted again for that speaker 14. In embodiments, the system 10 may operate to increase volume out of a speaker 14 as the user moves closer to the volume control device 30 associated with the speaker 14 and thereby the associated speaker 14 and decrease volume out of a speaker 14 as the user moves closer to the volume control device 30 associated with the speaker 14 and thereby the associated speaker 14. In this way, system 10 operates to pair a virtual, in-headset picture with an external audio stimulus. It will be appreciated that the virtual environment or mixed environment may determine how the volume will be adjusted.

The system 10 may be used in an augmented reality system or mixed reality system, wherein the system 10 may be paired with augmented reality and location system via a mobile app. As the system notices the user 22 getting closer to the speaker 14, sound emitted from the speaker 14 is increased or decreased.

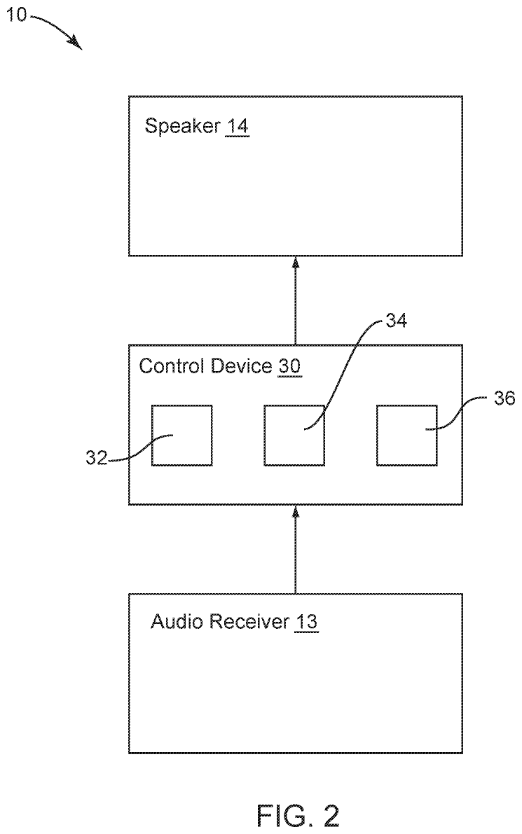

Referring further to the drawings, FIG. 2 depicts a block diagram of presence-based volume control system 10, wherein the system 10 is only depicting one channel, but may be used with multiple channels. The receiver 13 may direct audio out from the receiver 13 and into the volume control device 30. The volume control device 30 may process the audio signal 13 and send it out from the volume control device 30 into the speaker 14 for emitting the sound at a particular volume level. The volume control device 30 may include a processor 32, a sensor 34 and an amplifier 36. The volume control device 30 is coupled adjacent to one speaker 14 and in-line with the speaker 14 that the volume control device 30 intends to control. The processor 32 may be coupled to a small memory with firmware or other light application software for processing data supplied by the sensor 34, wherein the data supplied by the sensor 34 includes a user's location with respect to the sensor 34. The processor 34 automatically controls the amplifier 36 in order to adjust the volume based on the location of the user to the volume control device 30. Since the volume control device 30 is coupled adjacent the speaker 14, the volume control device adjusts the volume based on the location of the user to the speaker 14. Further still, since multiple speakers 14 are coupled within a room 12, the volume of speaker 14 adjust in response to the location of the user within the room 12.

In use with an entire home entertainment surround sound system with a plurality of speakers 14, each speaker may include a volume control device 30 coupled adjacent and in-line with one speaker 14. Each of the volume control devices 30 operate independently from the all other volume control devices 30. In this way, each speaker 14 may have its volume adjusted in response to a user moving throughout the room, wherein each sensor 34 of each volume control device 30 determines the user's location with respect to the speaker 14 coupled to the volume control device 30 and adjust the volume of that particular speaker 14 based on the location of the user, thereby creating a sound environment that matches the VR, AR or MR environment being viewed by the user 20 using device 22, as depicted in FIG. 1.

In embodiments, the position sensor 34 may be, but is not limited to a sonar sensor, and infrared sensor, or the like. Additionally, the processor 32 may be a microprocessor such as, but not limited to an Arduino processor, a Raspberry Pi Zero processor, or the like.

It will further be understood that software may be incorporated into the operation of the system in order to adjust the volume using the amplifier by processing the location of the user and providing instruction to the amplifier to increase or decrease the volume of a speaker the volume control device is coupled to.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A presence-based volume control system for mixed reality, virtual reality or augmented reality, the system comprising:
a surround sound receiver; and
a volume control unit coupled in-line between a speaker and the surround sound receiver, the volume control unit comprising:
a microprocessor;
a position sensor coupled to the microprocessor;
an audio input coupled to the surround sound receiver;
an audio output coupled to the speaker; and
an audio amplifier coupled to and controlled by the microprocessor and coupled to the audio input and the audio output, wherein the position sensor determines a position of a user of a virtual reality device, an augmented reality device or a mixed reality device and the microprocessor automatically adjusts a volume of the speaker coupled to the surround sound receiver in response to the proximity of the user to the speaker.

2. The system of claim 1, further comprising a virtual reality (VR) computer, wherein the virtual reality computer sound output is coupled to the surround sound receiver.

3. The system of claim 1, further comprising an augmented reality (AR) device, wherein the augmented reality device is paired with the surround sound receiver.

4. The system of claim 3, further comprising a mobile app operating on a mobile computing device, wherein the mobile app determines the location of the user with respect to the at least one speaker.

5. The system of claim 3, wherein the augmented reality device is virtual, in-headset picture, wherein the system provides external audio stimulus in response to operation of the system.

6. The system of claim 1, further comprising a mixed reality (MR) device, wherein the mixed reality device is paired with the surround sound receiver.

7. The system of claim 1, wherein the microprocessor decreases the audio output from the at least one speaker in response to the location of the user moving away from the at least one speaker.

8. The system of claim 1, wherein the microprocessor increases the audio output from the at least one speaker in response to the location of the user moving closer to the at least one speaker.

9. A presence-based volume control system for mixed reality, virtual reality or augmented reality, the system comprising:
a surround sound receiver having multiple audio channels; and
a plurality of volume control units, wherein each volume control unit coupled in-line between a speaker associated with one audio channel of the multiple audio channels and the surround sound receiver, each volume control unit comprising:
a microprocessor;
a position sensor coupled to the microprocessor;
an audio input coupled to the surround sound receiver;
an audio output coupled to the speaker; and
an audio amplifier coupled to and controlled by the microprocessor and coupled to the audio input and the audio output, wherein the position sensor determines a position of a user of a virtual reality device, an augmented reality device or a mixed reality device and the microprocessor automatically adjusts a volume of the speaker associated with the one audio channel coupled to the surround sound receiver in response to the proximity of the user to the speaker.

10. The system of claim 9, further comprising a virtual reality (VR) computer, wherein the virtual reality computer sound output is coupled to the surround sound receiver.

11. The system of claim 9, further comprising an augmented reality (AR) device, wherein the augmented reality device is paired with the surround sound receiver.

12. The system of claim 11 further comprising a mobile app operating on a mobile computing device, wherein the mobile app determines the location of the user with respect to the at least one speaker.

13. The system of claim 11, wherein the augmented reality device is virtual, in-headset picture, wherein the system provides external audio stimulus in response to operation of the system.

14. The system of claim 9, further comprising a mixed reality (MR) device, wherein the mixed reality device is paired with the surround sound receiver.

15. The system of claim 9, wherein the microprocessor of each volume control unit decreases the audio output from each speaker in response to the location of the user moving away to each speaker.

16. The system of claim 9, wherein the microprocessor of each volume control unit increases the audio output from each speaker in response to the location of the user moving closer to each speaker.

17. A presence-based volume control system for mixed reality, the system comprising:
a surround sound receiver having multiple audio channels;
a mixed reality (MR) device paired with the surround sound receiver; and
a plurality of volume control units, wherein each volume control unit coupled in-line between a speaker associated with one audio channel of the multiple audio channels and the surround sound receiver, each volume control unit comprising:
a microprocessor;
a position sensor coupled to the microprocessor;
an audio input coupled to the surround sound receiver;
an audio output coupled to the speaker; and
an audio amplifier coupled to and controlled by the microprocessor and coupled to the audio input and the audio output, wherein:
each volume control unit of the plurality of volume control units operates independently from the other volume control units; and
the position sensor of each volume control unit determines a position of a user of a virtual reality device, an augmented reality device or a mixed reality device and the microprocessor automatically adjusts a volume of the speaker coupled to the volume control unit coupled to the speaker in response to the proximity of the user to the speaker in order to adjust the volume of all of the speakers of the system.

18. The system of claim 17, further comprising a mobile app operating on a mobile computing device, wherein the mobile app determines the location of the user with respect to the at least one speaker.

19. The system of claim 17, wherein the microprocessor of each volume control unit decreases the audio output from each speaker in response to the location of the user moving away to each speaker.

20. The system of claim 17, wherein the microprocessor of each volume control unit increases the audio output from each speaker in response to the location of the user moving closer to each speaker.
